(19) United States
(12) Patent Application Publication
(10) Pub. No.: US 2008/0130625 A1
(43) Pub. Date: Jun. 5, 2008

(54) DIGITAL WIRELESS COMMUNICATION SYSTEM

(75) Inventor: Shigeo Sato, Tokyo (JP)

Correspondence Address: INTELLECTUAL PROPERTY / TECHNOLOGY LAW, PO BOX 14329, RESEARCH TRIANGLE PARK, NC, 27709, US

(73) Assignee: UNIDEN CORPORATION, Tokyo (JP)

(21) Appl. No.: 11/697,863

(22) Filed: Apr. 9, 2007

(30) Foreign Application Priority Data
Nov. 30, 2006 (JP) 2006-324168

(51) Int. Cl. H04J 3/06

(52) U.S. Cl. 370/350; 370/514

(57) ABSTRACT

A mobile station includes a timing controller for adjusting a frame transmit timing so that a unique word detection position at a base station is always located on a predetermined position. Even when frequent changes in the distance between the base station and mobile station occur due to movement of the mobile station, synchronization between the stations can be established, and this synchronization can be maintained.

### CROSS-REFERENCE TO RELATED APPLICATION

This application claims priority under 35 USC §119 of Japanese Patent Application No. 2006-324168 filed on Nov. 30, 2006.

### BACKGROUND

The present invention relates to a digital wireless communication system in which wireless communication is performed between a base station and a mobile station using Time Division Multiple Access.

Commonly used modes of cordless telephone systems include home telephone cordless systems configured from a base station and a plurality of mobile stations, and a cordless PBX (Private Branch Exchange) in which a plurality of base stations arranged in a building or campus can be accessed by an mobile station. These types of cordless telephone systems often employ a TDD (Time Division Duplex) system based on a digital modulation method. For example, in the method of wireless access between a base station and a mobile station used in second generation cordless telephone systems which uses a 4-channel multiplex multi-carrier TDMA/TDD (Time Division Multiple Access/Time Division Duplex) which performs a time-division sharing of a single frequency, voice data and control signals are alternately transmitted and received in each of the ascending direction from the mobile station to the base station and the descending direction from the base station to the mobile station.

### SUMMARY

In a TDD system disclosed in Japanese Unexamined Patent Application No. 2005-269062, a transmission apparatus transmits a frame in which a synchronization pattern known as a unique word (synchronization word) has been inserted to a reception apparatus for the purpose of either maintaining the synchronization of the system or identifying the transmission frame. The reception apparatus calculates a correlation value between a reference unique word stored in a register in advance and the unique word inserted in the reception frame and, based on detection of the peak thereof, establishes synchronization between the transmission apparatus and the reception apparatus.

However, for short distance communication premised on the distance between the base station and the mobile station being a close distance of less than 1 km, it is sufficient for a fixed value of both the frame transmit timing and transmit power from the mobile station to the base station to be set in advance. For this reason, an inexpensive communication system in which complicated transmit timing control and transmit power control is unnecessary can be provided.

However, assuming a modulation speed for communication of 128 kbps the time taken to transmit one bit is 7.8 μsec, the light-speed converted distance equivalent thereto being approximately 2340 m. When the distance the mobile station is away from the base station is at least 1170 m, a displacement between the stations of at least one bit occurs.

For this reason, in long distance communication premised on the distance between the base station and the mobile station being a long distance of at least 1 km, the frame transmit timing and transmit power from the mobile station to the base station must be controlled in accordance with the distance between the stations. More particularly, for special use cordless telephone systems premised on the distance between the base station and the mobile station being a very long distance apart of the order of 8 km, the establishment of accurate synchronization of the system and efficient transmit power control are indispensable.

The same applies to communication systems in which digital modulation is employed, wherein the distance between the stations does not present a problem in FDD systems in which there is no need for synchronization to be established between the base station and the mobile station, in TDD systems in which there is a need for synchronization to be established between the stations, the frame transmit timing and transmit power from the mobile station to the base station must be controlled in accordance with the distance between the stations in order to maintain communication quality.

Thereupon, it is an object of the present invention to provide a digital wireless communication system in which, to resolve this problem, the frame transmit timing or transmit power from a mobile station to a base station can be controlled in accordance with the distance between the stations.

In order to resolve this problem, the digital wireless communication system pertaining to the present invention includes a base station, and a mobile station that performs wireless communication with this base station using Time Division Multiple Access. The mobile station includes a timing controller for adjusting the frame transmit timing so that a unique word detection position detected at the base station always constitutes a predetermined position.

Based on this configuration, even when the distance between the stations changes due to movement of the mobile station, synchronization is established between the stations and, in addition, this synchronization can be maintained.

The mobile station further includes a mode for controlling the transmit power in accordance with the unique word detection position detected at the base station.

Based on this configuration, even when the distance between the stations changes due to the movement of the mobile station, optimum transmit power control can be realized in accordance with the distance between the stations.

The base station includes a unique word detector for detecting the unique word included in the fame transmitted from the base station, and a modem for notifying the mobile station of the unique word detected position detected by the unique word detector. The mobile station adjusts the frame transmit timing on the basis of the unique word detection position notified from the base station so that the unique word detection position detected at the base station constitutes a predetermined position.

Based on this configuration, the mobile station is able to adjust the frame transmit timing so that the unique word detection position detected at the base station is always located on a predetermined position.

If the unique word transmitted from the mobile station cannot be detected, the base station demodulates the data transmitted from the mobile station assuming the unique word as having been detected in the predetermined position.

Based on this configuration, stable communication can be maintained even when the base station cannot detect the unique word.

### DESCRIPTION OF DRAWINGS

FIG. 1 is a system block diagram of a cordless telephone system pertaining to one embodiment of the present invention;

FIG. 2 is an explanatory diagram showing the configuration of a frame employed for wireless communication in Time Division Multiple Access;

FIG. 3 is a function block diagram of a mobile station pertaining to this embodiment;

FIG. 4 is a table illustrating the correlative relationship between bit number, light speed converted distance equivalent to the transmission time thereof, and transmit power level; and

FIG. 5 is an explanatory diagram of a unique word detection window pertaining to this embodiment.

### DETAILED DESCRIPTION

An embodiment of the present invention will be explained hereinafter with reference to the drawings.

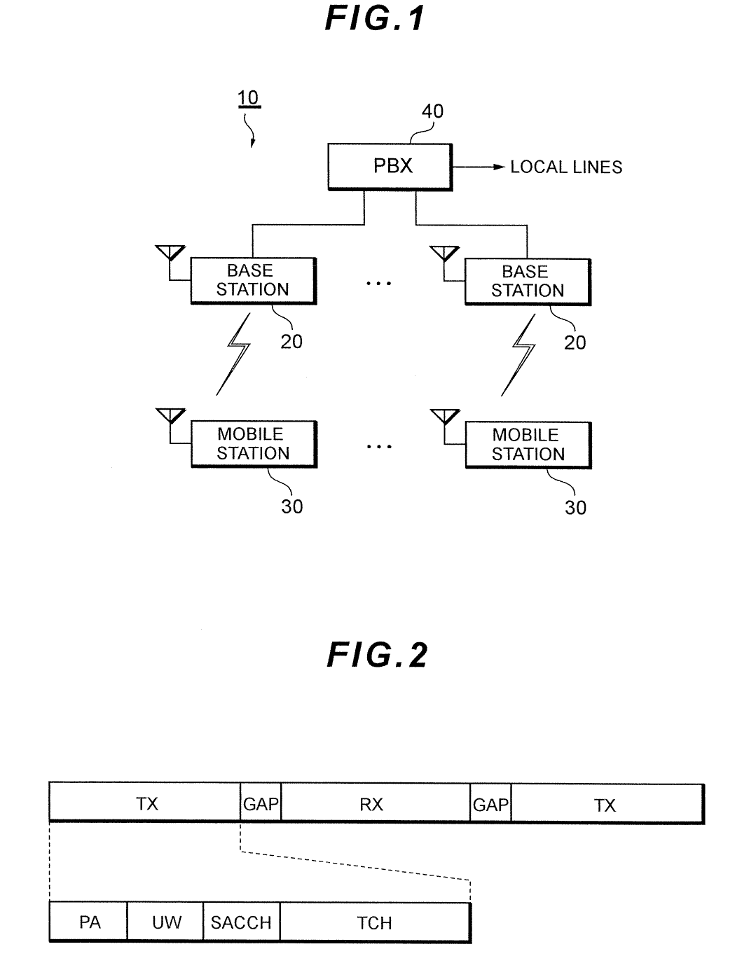

FIG. 1 shows the system configuration of a cordless telephone system 10 pertaining to this embodiment.

The cordless telephone system 10, which operates as a private business-use digital wireless communication system, includes base station 20, mobile stations 30 and a PBX 40. The PBX 40 operates as a main apparatus arranged in the private business location to which local lines are connected. A plurality of base stations 20 for indoor or outdoor communication are connected to the PBX 40. The mobile stations 30 perform wireless communication with the master stations 20 using Time Division Multiple Access.

FIG. 2 shows the configuration of a frame employed in wireless communication using Time Division Multiple Access.

The symbol TX in the diagram denotes the frame transmitted by the base station 20, while the symbol RX denotes the frame received by the base station 20. The symbol GAP denotes a guard time segment in which there is neither a communication operation nor a reception operation performed by the base station 20. The base station 20 executes a switchover from the transmission operation to the reception operation of the frame or a switchover from the reception operation to the transmission operation of the frame in the guard time segment. Each of the TX and the RX includes a preamble (PA) that indicates the frame head, a unique word (UW) for establishing synchronization, a slow associated control channel (SACCH) for transmitting and receiving control information between the stations, and a traffic channel (TCH) for storing of voice data and so on.

While the mobile station 30 cannot surmise the timing set by the base station 20 itself at the communication start point, synchronization between the stations can be established as a result of detection of a unique word inserted in the frame transmitted from the base station 20. The base station 20 detects the unique word assuming the frame transmitted from the mobile station 30 is synchronized with the timing set by the base station 20 itself.

Moreover, in digital wireless communication systems of this type, in order to maintain synchronization between the stations the data following the unique word is sometimes scrambled to prevent the signal being modulated being biased to “1” or “0”. The accurate detection of the position of the unique word in the frame is essential from the viewpoint of accurately demodulating the data following the unique word.

When the unique word cannot be detected due to obstructions such as noise including electromagnetic interference or buildings and so on, the digital wireless communication system is able to accurately demodulate the data following the unique word by, based on the premise that the detection position of the unique word is constant, utilizing the position of the previously detected unique word.

In this way, detection of the unique word in digital wireless communication systems is essential for accurate demodulation of a reception frame. When the detected position of the unique word is stabilized (or is fixed), the data following the unique word can be accurately demodulated even when the position of the unique word cannot be detected by utilizing of the previously detected position of the unique word.

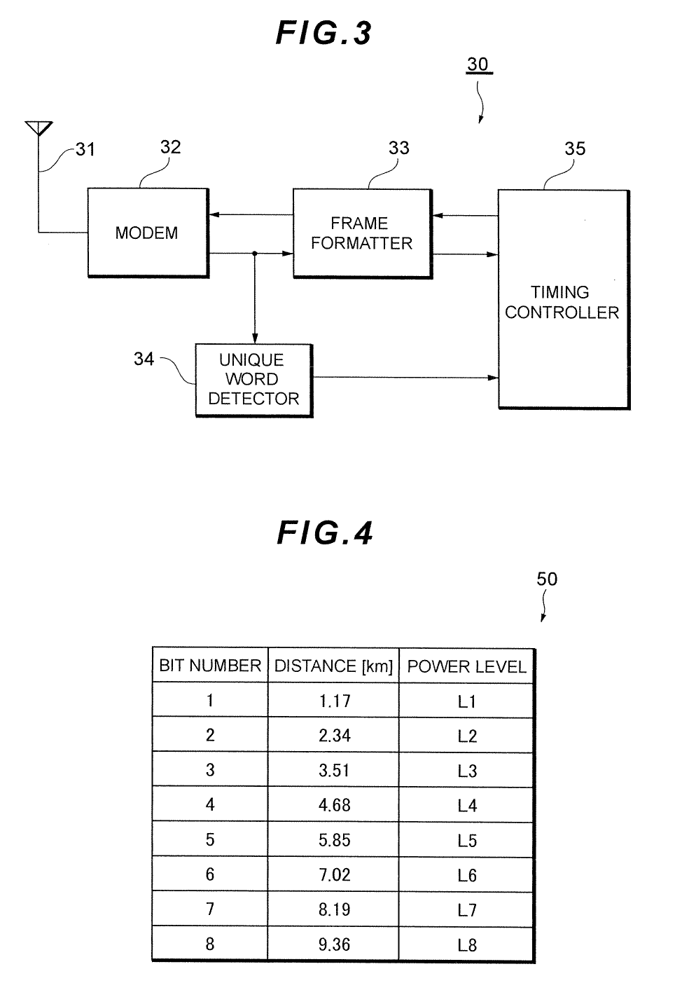

FIG. 3 shows a function block of the mobile station 30 pertaining to this embodiment.

The mobile station 30 includes an antenna 31, modem 32, frame formatter 33, unique word detector 34 and timing controller 35.

The modem 32 operates as a high frequency modulation/demodulation circuit that modulates a baseband signal (frame) transferred from the frame formatter 33 to a wireless frequency band, performs a wireless transmission of this modulated wireless signal to the base station 20 by way of the antenna 31, and demodulates the received wireless signal from the base station 20 by way of the antenna 31 to a baseband signal. Furthermore, the modem 32 performs a later-described transmit power control.

The unique word detector 34 calculates a correlation value between a reference unique word stored in a register in advance and a unique word inserted in the reception frame and, by detection of the peak thereof, detects the position of the unique word in the frame. It then notifies the timing controller 35 of the detected position of the unique word.

While on the own hand the frame formatter 33 produces a transmission frame, it disassembles the reception frame on the basis of the unique word position detection notified from the timing controller 35.

Moreover, the function block of the base station 20 is the same as the function block of the mobile station 30 and, accordingly, a detailed description thereof has been omitted.

FIG. 4 shows a Table 50 that illustrates the correlative relationship between bit number, light speed converted distance equivalent to the transmission time thereof, and transmit power level. The Table 50 displays values at a modulation speed of 128 kbps.

It is clear from Table 50 that when the distance between the base station 20 and the mobile station 30 is 1.17 km the reception position of the unique word received from the mobile station 30 by the base station 20 is delayed by a 1-bit amount comparative to the reception position when the distance between the stations is a close distance (for example a distance less than 1.17 km). Furthermore, Table 50 indicates that when the distance between the stations is 1.17 km the transmit power level for transmission and reception of the wireless signal between the stations must be at least L1.

Moreover, while the transmit power level is divided in the Table 50 into 8 stages correspondent to each bit number for the purpose of simplicity of the explanation, it is not necessarily the case that the transmission must be performed at the transmit power level stored in the Table 50 as long as it is performed at a transmit power of at least the transmit power level stored in the Table 50. For example, dividing the transmit power level into 4 stages, the transmit power level when the distance between the stations is 2.34 km may be L2, the transmit power level when the distance between the stations is 4.68 km to 2.34 km may be L4, the transmit power level when the distance between the stations is 7.02 km to 4.68 km may be L6, and the transmit power level when the distance between the stations is 9.36 km to 7.02 km may be L8.

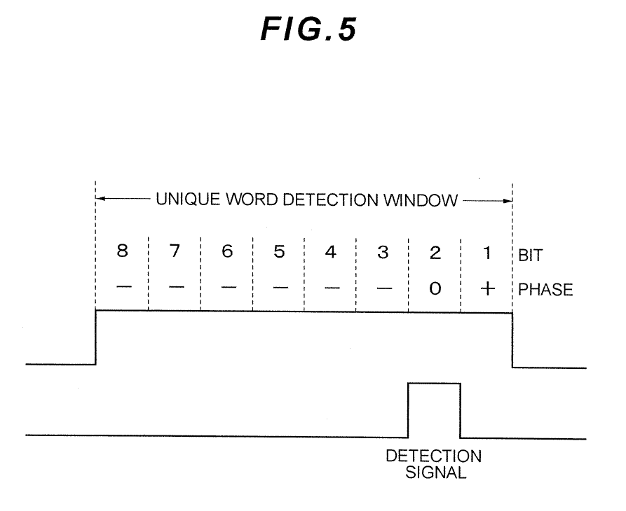

Next, referring to FIG. 5, the method by which the mobile station 30 controls the transmit timing and the transmit power of the wireless signal in accordance with the distance between the stations will be explained.

The unique word detector of the base station 20 includes an 8-bit width unique word detection window. A detection signal indicates the detection position (bit position) of the unique word. Here, for the purpose of simplicity of the explanation, the movement range of the mobile station 30 able to be hypothesized as being in the usage normal mode is in the vicinity of a radius 2.34 km taking the base station 20 as the point of origin. When the distance between the base station 20 and the mobile station 30 is within this range, the base station 20 detects the unique word in a 2^{nd} bit position of the unique word detection window. Accordingly, the 2^{nd} bit position of the unique word detection window is defined as being the normal position (zero phase difference). According to this definition, the unique word is detected in the 1^{st} bit position (phase advance) of the unique word detection window even when the distance between the base station 20 and the mobile station 30 is shorter than the range described above, On the other hand, when the distance between the base station 20 and the mobile station 30 is longer than this range the unique word is detected in 3^{rd} to 8^{th} bit positions (delay phase) of the unique word detection window.

Moreover, while the 2^{nd} bit position of the unique word detection window is defined as the normal position in the example described above, the normal position can be arbitrarily defined in accordance with the movement range of the mobile station 30. The unique word detector 34 of the mobile station 30 also includes an 8-bit width unique word detection window.

Thereupon, when communication between the base station 20 and the mobile station 30 begins, the base station 20 transmits an access request via a wireless signal to the mobile station 30. Upon receipt of the access request from the base station 20, the mobile station 30 detects the unique word inserted in this wireless signal and identifies it as being a call from the base station 20. Subsequently, the mobile station 30 begins transmitting an access permission via a wireless signal to the base station 20 at a default timing set in advance.

The base station 20 judges at what position of the 8-bit width unique word detector the unique word has been detected. The base station 20 then insert the information of the unique word detected position (bit position within the unique word detection window) into a SACCH and notifies the mobile station 30 of the unique word detected position. For example, if the unique word is detected at the 7^{th} bit position of the unique word detection window, the base station 20 notifies the mobile station 30 of information indicating a bit position “7”.

Because the timing controller 35 of the mobile station 30 is aware in advance that the bit position “2” is the normal position, when the information received from the base station 20 indicates that the unique word position is the bit position “7”, it adjusts the transmit timing to begin data transmission from a 5-bit delayed position. Because the mobile station 30 includes this function whereby it is able to dynamically adjust the data transmission timing in accordance with the unique word detection position detected at the base station 20 in this way, even if the distance between the base station 20 and the mobile station 30 changes as a result of movement of the mobile station 30, the base station 20 is able to stably detect the unique word in the normal bit position “2”. Furthermore, even when a unique word is not detected by the base station 20, the base station 20 is able to accurately demodulate the data following the unique word on the basis of it being inferred that the unique word detection position is the bit position “2”.

In addition, the mobile station 30 supports the Table 50 and adjusts the transmit power level in accordance with the distance between the stations. The distance between the stations can be inferred from the normal position defined as being within the unique word detection window and how many bits the transmit timing of the mobile station 30 is displaced so that the unique word detection position at the base station 20 constitutes the normal position. For example, in the example described above, because the normal position is the bit position “2” and the mobile station 30 performs data transmission from a 5-bit delayed position, the distance between the stations is inferred as being approximately 8.19 km. Thereupon, the modem 32 of the mobile station 30 sets the transmit power level to at least L7. On the other hand, the base station 20 also supports the Table 50, infers the distance between the stations on the basis of the unique word detection position, and adjusts the transmit power level.

Moreover, a drop in the reception power of the base station 20 or the mobile station 30 is likely to occur not only when the distance between stations changes but also when structures such as buildings cause interference to the electromagnetic wave propagation. In this case, in addition to the transmit power control based on the distance between the stations, it is preferable that a correlation value and so on of received electric field intensity (RSSI) and a digital matched filter be utilized to adjust the transmit power.

According to this embodiment, even when the distance between stations changes as a result of movement of the mobile station 30, synchronization between the stations can be established and maintained and, furthermore, transmit power can be appropriately controlled. In addition, the system configuration can be simplified by comparison to a method for adjusting the transmit timing of the base station 20 to the transmit timing of the mobile station 30.

We claim:

1. A digital wireless communication system comprising a base station and a mobile station that performs wireless communication with the base station using Time Division Multiple Access,
the mobile station comprising a timing controller for adjusting frame transmit timing so that a unique word detection position at the base station is always located on a predetermined position.

2. The digital wireless communication system according to claim 1,
the mobile station further comprising a modem for controlling transmit power on the basis of the unique word detection position at the base station.

3. The digital wireless communication system according to claim 1,
the base station comprising a unique word detector for detecting a unique word included in a frame transmitted from the mobile station, and a modem for notifying the mobile station of the unique word detection position detected by the unique word detector,
wherein the mobile station adjusts the frame transmit timing on the basis of the unique word detection position notified from the base station so that the unique word detection position at the base station is located on the predetermined position.

4. The digital wireless communication system according to claim 1,
wherein the base station demodulates data transmitted from the mobile station assuming that the unique word has been detected at the predetermined position when the base station cannot detect the unique word transmitted from the mobile station.
